(19) United States
(12) Patent Application Publication
(10) Pub. No.: US 2006/0071356 A1
(43) Pub. Date: Apr. 6, 2006

(54) Method for separating excess material from a lens mold

(76) Inventor: Kevin Beebe, Spencerport, NY (US)

Correspondence Address: Bausch & Lomb Incorporated, One Bausch & Lomb Place, Rochester, NY, 14604-2701, US

(21) Appl. No.: 10/958,022

(22) Filed: Oct. 4, 2004

(51) Int. Cl. B29D 11/00

(52) U.S. Cl. 264/2.2; 425/808

(57) ABSTRACT

A method and apparatus for separating excess cured lens material, or lens flash, from the mold section in which it was cast. This invention is particularly suited for cast contact lenses or intraocular lenses.

### FIELD OF THE INVENTION

This invention relates to a method for separating excess cured lens material, or lens flash, from the mold section in which it was cast. This invention is particularly suited for cast contact lenses or intraocular lenses.

### BACKGROUND OF THE INVENTION

Static cast molding of ophthalmic lenses, including contact lenses and intraocular lenses, has proved successful commercially. Static cast molding involves charging a mixture of lens-forming monomers between two mold sections. One mold section is shaped to form the anterior, convex lens surface (also referred to as female mold section) and the other mold section is shaped to form the posterior, concave lens surface (also referred to as male mold section). This monomer mixture is cured in the lens-forming mold cavity formed between the anterior and posterior molding surfaces, typically by exposure to light energy and/or thermal energy. Such methods are described in U.S. Pat. Nos. 3,408,429, 3,660,545, 4,113,224, 4,197,266, and 5,271,875, as examples.

More specifically, the liquid monomer mixture is charged to the anterior mold, and then the posterior mold is seated on the anterior mold, to define the lens-forming molding cavity therebetween. Typically, an excess amount of monomer mixture is deposited, in order to ensure the mold cavity is completely filled. This excess liquid monomer mixture is dispelled from the molding cavity, generally into some type of reservoir in the anterior mold section surrounding the molding cavity. When the monomer mixture in the molding cavity is cured to form the lens, this excess monomer mixture is also cured, resulting in excess cured polymer material. Often, this excess cured material has the form of a ring, and thus, is sometimes referred to as a monomer ring; it is also sometimes referred to as lens flash. This excess material tends to adhere to one of the mold sections, and similarly, the contact lens tends to adhere to one of the mold sections.

In some cast molding methods, the contact lens is purposely retained on one mold section (for example, the anterior mold section) while the excess cured material is retained on the other mold section (for example, the posterior mold section). U.S. Pat. No. 5,271,875 (Appleton et al.), U.S. Pat. No. 6,033,603 (Lesczynski et al.) and U.S. Patent Application Publication 2003/0160343-A1 (Hodgkinson) disclose such methods.

In some other cast molding methods, both the contact lens and the excess cured material are retained on the same mold section (for example, the anterior mold section). As an example, U.S. Pat. No. 6,368,096 (Dobner et al.) discloses an apparatus for separating cured excess lens polymer material from a contact lens mold section. This apparatus involves piercing this ring of excess material, in a manner that this ring is sheared from the mold section in which it is retained. The ring is then removed from the mold section, and the mold section, now containing only the contact lens, is transferred to downstream processes, for example, to a station for releasing the contact lens from the mold section. While this apparatus is quite useful, difficulties may be encountered when the ring of excess lens material has a relatively low volume, or when the excess lens material is very brittle. For example, the pins or blades that pierce the monomer ring may break the ring into several smaller pieces. These smaller pieces are more difficult to remove, and some pieces may remain on the contact lens.

### SUMMARY OF THE INVENTION

This invention provides an improved method for separating excess cured lens material from the mold section in which it was cast and is retained.

The method comprises: casting a lens in a mold assembly, wherein excess cured material is adhered to a mold section of the mold assembly; compressing the excess cured lens material to disengage the excess cured material from the mold section; and removing the excess cured material from the mold section.

Preferably, the excess cured lens material is compressed at two opposed points, thereby deflecting the excess cured lens material. To accomplish this, the excess lens material may be compressed by a wedge-shaped groove. Preferably, the wedge-shaped groove has two opposed, tapered surfaces that contact and deflect the excess cured lens material as the mold section is moved against the groove.

According to certain embodiments, the cast lens is also adhered to the anterior mold section, and the excess cured material is removed from the cast lens and anterior mold section. The cast lens may remain adhered to a molding surface of the anterior mold section, after removal of the excess cured lens material.

According to other preferred embodiments, the excess cured lens material is transported through two opposed, tapered surfaces that compress the excess cured lens material. Preferably, the excess cured lens material is contacted by the opposed, tapered surfaces that compress and deflect the excess cured lens material as the mold section travels through and is guided by a separate pair of opposed surfaces.

This invention also provides an apparatus for carrying out the method.

### BRIEF DESCRIPTION OF THE DRAWING FIGURES

FIG. 1 is a schematic exploded view of a representative mold assembly for use in the invention.

FIG. 2 is a partial, cross-sectional view of the mold assembly of FIG. 1 being assembled.

FIG. 3 is a partial, cross-sectional view of the mold assembly of FIGS. 1 and 2 after curing of a lens.

FIG. 4 is a top perspective view of an apparatus according to various preferred embodiments of this invention.

FIG. 5 is a bottom perspective view of the apparatus of FIG. 4.

FIG. 6 is a bottom plan view of the apparatus of FIGS. 4 and 5.

FIG. 7 is a frontal plan view of the apparatus of FIGS. 4, 5 and 6.

FIG. 8 is a partial cross-sectional view of the apparatus of FIGS. 4, 5, 6 and 7, as viewed from above along line A-A, the apparatus further including a mold section.

FIG. 9 is a bottom plan view of an alternate apparatus of this invention.

### DETAILED DESCRIPTION OF PREFERRED EMBODIMENTS

As mentioned, this invention is useful in the casting of ophthalmic lenses, including contact lenses and intraocular lenses. For illustrative purposes, the following description of preferred embodiments will refer mainly to static cast molded contact lenses, although the invention is applicable for other ophthalmic lenses, and for other casting methods such as spincasting.

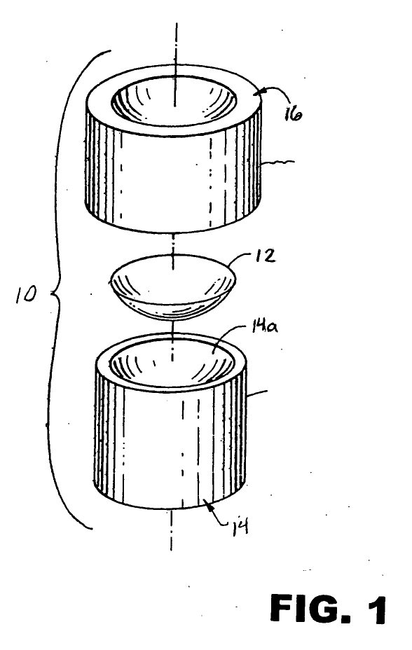

FIGS. 1 to 3 illustrate a known mold assembly 10 for the static casting of a contact lens 12. Assembly 10 includes a posterior (or male) mold section 16 having a molding surface 16a for forming a posterior contact lens surface. Assembly 10 also includes an anterior (or female) mold section 14 having a molding surface 14a for forming an anterior contact lens surface. It will be appreciated, however, that this invention is applicable to other lens molds having configurations differing from the illustrated embodiment.

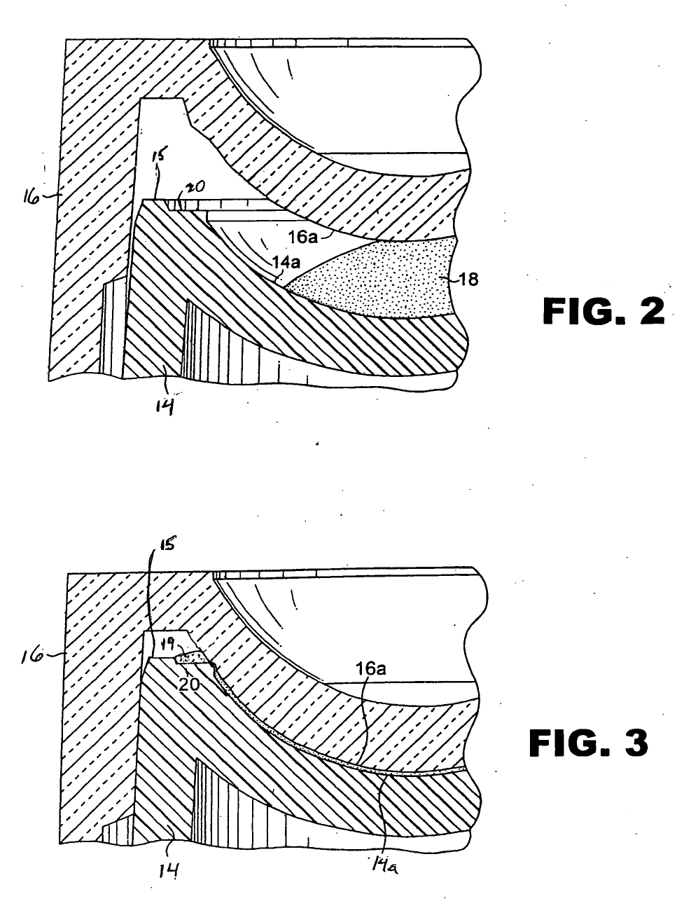

As seen in FIG. 2, a liquid mixture of lens-forming monomers 18 is deposited on the molding surface 14a of the anterior mold 14. Then, as seen in FIG. 3, the posterior mold 16 is seated on the anterior mold, whereby the lens-forming molding cavity is defined between molding surfaces 14a and 16a. Typically, an excess amount of monomer mixture 18 is deposited, in order to ensure the molding cavity is completely filled. This excess liquid monomer mixture 19 is dispelled from the molding cavity, into reservoir 20 in the anterior mold section. In the illustrated embodiment, reservoir 20 has the form of a circumferential groove surrounding the molding cavity.

The monomer mixtures employed in the invention include conventional lens-forming monomers. The lens-forming monomers are monomers that are polymerizable by free radical polymerization, generally including an activated unsaturated radical, such as an ethylenically unsaturated radical. (As used herein, the term “monomer” denotes relatively low molecular weight compounds that are polymerizable by free radical polymerization, as well as higher molecular weight compounds also referred to as “prepolymers”, “macromonomers”, and related terms.)

One preferred class of lens-forming monomers is those that form hydrogel copolymers. A hydrogel is a crosslinked polymeric system that can absorb and retain water in an equilibrium state. Accordingly, for hydrogels, the monomer mixture will typically include a hydrophilic monomer. Suitable hydrophilic monomers include: unsaturated carboxylic acids, such as methacrylic and acrylic acids; acrylic substituted alcohols, such as 2-hydroxyethylmethacrylate (Hema) and 2-hydroxyethylacrylate; vinyl lactams, such as N-vinyl pyrrolidone; and acrylamides, such as methacrylamide and N,N-dimethylacrylamide (DMA). The hydrophilic monomer may function as a crosslinking agent (a crosslinker being defined as a monomer having multiple polymerizable functionalities) or a separate crosslinker may be employed. Examples of crosslinking agents are ethyleneglycoldimethacrylate, tetraethyleneglycoldimethacrylate, and 2-ethylenemethacrylate vinyl carbonate.

Another preferred class of lens-forming monomers includes those that form silicone copolymers. Such systems include a silicone-containing monomer. One suitable class of silicone containing monomers include known bulky, monofunctional polysiloxanylalkyl monomers, such as methacryloxypropyl tris(trimethylsiloxy)silane, pentamethyldisiloxanyl methylmethacrylate, tris(trimethylsiloxy) methacryloxy propylsilane, methyldi(trimethylsiloxy)methacryloxymethyl silane, 3-[tris(trimethylsiloxy)silyl] propyl vinyl carbamate, and 3-[tris(trimethylsiloxy)silyl] propyl vinyl carbonate. Another suitable class includes multifunctional ethylenically “end-capped” siloxane-containing monomers, especially difunctional monomers. Other silicone-containing monomers include the silicone-containing monomers described in U.S. Pat. Nos. 5,034,461, 5,610,252 and 5,496,871, the disclosures of which are incorporated herein by reference. Other silicone-containing monomers are well-known in the art.

In the case of silicone hydrogels, the monomer mixture includes, in addition to the silicone-containing monomer, a hydrophilic monomer. Either the silicone-containing monomer or the hydrophilic monomer may function as a crosslinking agent (a crosslinker being defined as a monomer having multiple polymerizable functionalities) or a separate crosslinker may be employed.

In the case of intraocular lenses, the monomer mixtures may further include a monomer for increasing the refractive index of the resultant copolymer. Examples of such monomers are aromatic (meth) acrylates, such as phenyl (meth)acrylate, phenylethyl (meth)acrylate and benzyl (meth)acrylate.

Generally, the lens-forming monomer mixtures will include a polymerization initiator to facilitate curing of the monomer mixture. This mixture may include other optional components such as UV absorbing agents and tinting agents.

After depositing the monomer mixture and assembling the posterior and anterior molds, the mold assembly shown in FIG. 3 can now be exposed to light energy (for example, UV radiation) and/or thermal energy. For curing with light energy, at least one of the mold sections is transparent to the light energy; thus, the mold sections may be formed of materials such as polypropylene, polystyrene, or other transparent plastic resins. At completion of curing, the monomer mixture in the molding cavity has been cured to form contact lens 12, and the excess monomer mixture 19 in reservoir 20 has also been cured. For the illustrated embodiment, the cured excess monomer mixture 19 may have the form a ring, thus, this cured excess material is sometimes referred to as a monomer ring; it is also sometimes referred to as lens flash.

The posterior and anterior mold sections may now be separated from one another. This procedure is sometimes referred to as “decapping”, and various methods are known in the art, depending on the configurations of the mold sections, including those methods disclosed in U.S. Pat. No. 6,428,723 (Lesczynski et al.), U.S. Pat. No. 5,693,268 (Widman et al.) and U.S. Pat. No. 5,850,107 (Kindt-Larsen et al.), and U.S. Patent Application Publication 2003/0160343-A1 (Hodgkinson).

Following the decapping operation, according to the described embodiment, both the contact lens and the excess cured material are retained on the anterior mold section. Typically, the cast contact lens tends to adhere to the molding surface 14a of the anterior section 14, and the excess cured material 19 tends to adhere to the reservoir 20. In the illustrated embodiment, the excess cured material extends slightly above surface 15 of anterior mold section 14.

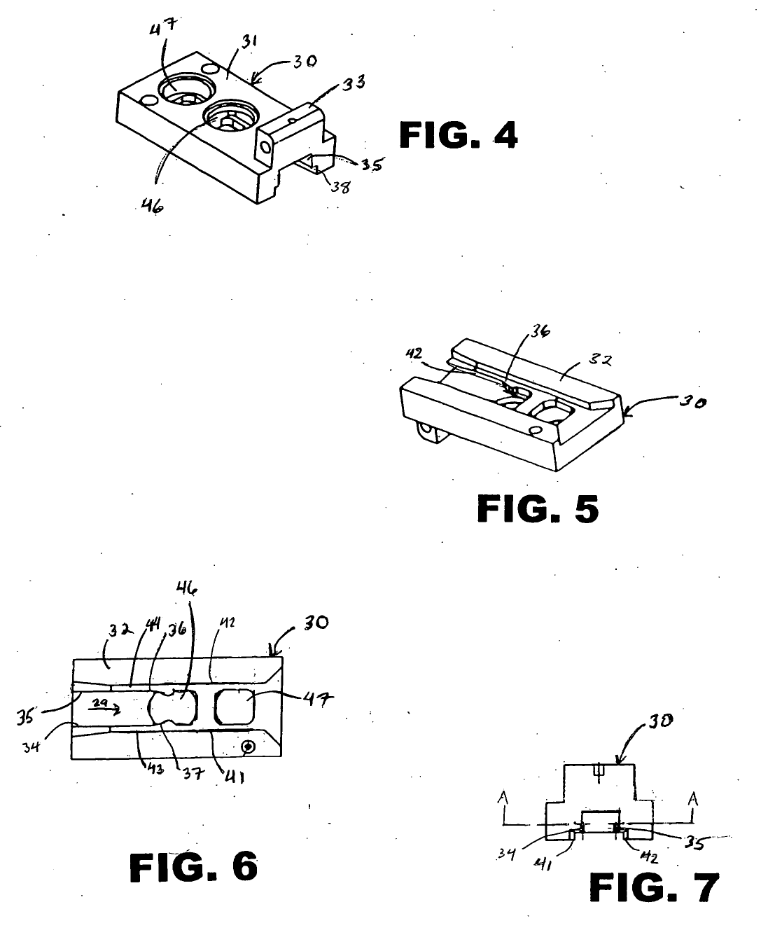

FIGS. 4 to 8 illustrates a first embodiment of an apparatus according to this invention. Plate 30 has an upper surface 31 and a lower surface 32. Extension 33 is optionally provided as a means to attach plate 30 to a support, for example, extension 33 may be hingedly connected to a support. A wedge-shaped groove 35 is formed in lower surface 32. Groove 32 is defined by two opposed, tapered surfaces 36, 37. A second groove 38 is formed in lower surface 32, groove 38 including a pair of opposed surfaces 41, 42. Mold section 14 is transported in the direction of arrow 29, for example, by a pusher device. As mold section 14 is transported in this direction, it may be supported on a support positioned below plate 30. Plate 30 may be spring biased so that it is compressed against, and remains in contact with, the top surface 15 of mold section 14 as the mold section is moved through and against groove 35.

Surfaces 41, 42 serve to guide the upper portion of mold section 14 as it is transported through plate 30. Thus, the spacing of surfaces 41, 42 (vertical in FIG. 6) closely approximates the outer diameter of the upper portion of mold section 14, as best seen in FIG. 8. The upper surface 15 of mold section 14 contacts surfaces 43, 44 (horizontal in FIG. 6). The opposed, tapered surfaces 34, 35 contact the excess cured lens material, and deflect this material as the mold section is moved therethrough. This compressive force on the excess cured lens material 19 thereby disengages this excess material from the reservoir 20, i.e., the adherence of the excess material to reservoir is broken.

At the completion of this operation, it is preferred that the contact lens remains adhered to the molding surface of anterior mold section 14. Also, it is preferred that the excess lens material remains in one piece as it is disengaged from the reservoir 20. However, even if the cured excess material is broken by this operation, it generally will be broken into only two or three larger pieces, i.e., this operation does not tend to shatter the cured excess material into many small pieces. Accordingly, the process of this invention ensures easy and complete removal of the cured excess material, while also ensuring the contact lens remains on mold section 14 for subsequent downstream operations.

In the illustrated embodiment, aperture 46 extends through upper surface 31, so that after loosening the excess cured material, the mold section may be accessed through aperture 46. Thus, after the mold section has traveled through the wedge-shaped groove, the loosened, non-adherent excess material 19 can be removed from mold assembly 14 and the contact lens retained therein. For example, the excess material can be removed by a vacuum pick-up at aperture 46, and discarded. Second aperture 47 is optionally provided so that mold assembly can be accessed by a second vacuum pick-up, in order to ensure all excess lens material is removed. As further examples, the excess material can be removed manually, removed with a picker device, or blown away with forced air.

Following these operations, the assembly of the mold section 14 and contact lens 12 retained therein can be transported to a downstream station for conventional post-molding processing. In the case of contact lenses, downstream processes may include at least one of: release of the lens from the mold; extraction of contaminants from the lens; surface treatment of a lens surface; inspection; hydration; and packaging. All such processes are well-known in the art.

In the embodiment illustrated in FIG. 4, the narrowest separation of the tapered surfaces 36, 37 is slightly smaller than the circumference of the ring of excess cured lens material. Also, this narrowest separation of the opposed tapered surfaces is smaller than the separation of surfaces 41, 42. At the point where mold section 14 is at the narrowest separation of surfaces 36, 37, these surfaces contact the excess cured material at points approximately 180 degrees from one another.

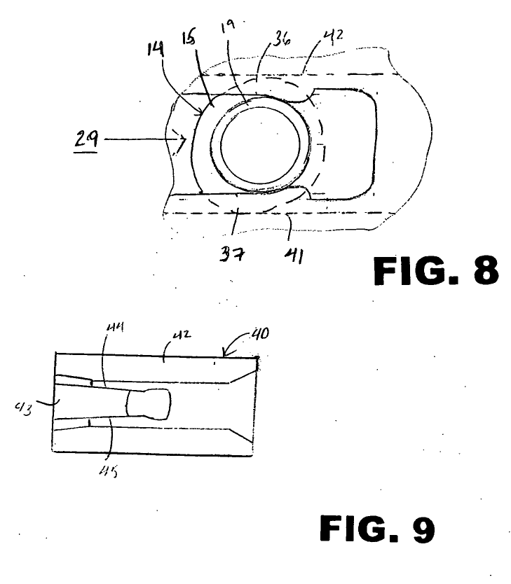

FIG. 9 illustrates an alternate embodiment of an apparatus according to this invention. Plate 40 has a lower surface 42. Wedge-shaped groove 43 is formed in lower surface 42, and groove 43 is defined by two opposed, tapered surfaces 44, 45 having a different configuration than in FIG. 4. These tapered surfaces 44, 45 serve to deflect the excess cured material, similar to the previously described embodiment, as mold section 14 is transported in the direction of arrow 46.

Although the invention has been described in connection with various preferred embodiments, numerous variations will be apparent to a person of ordinary skill in the art given the present description, without departing from the spirit of the invention and the scope of the appended claims. For example, modifications to the preferred embodiments will be evident when this invention is used for molds having different configurations, or when this invention is used in process where the excess cured material is retained on the posterior mold sections.

I claim:

1. A method comprising:
casting a lens in a mold assembly, wherein excess cured material is adhered to a mold section of the mold assembly;
compressing the excess cured lens material to disengage the excess cured material from the mold section; and
removing the excess cured material from the mold section.

2. The method of claim 1, wherein the excess cured lens material is compressed at two opposed points, thereby deflecting the excess cured lens material.

3. The method of claim 1, wherein the excess cured lens material is compressed by a wedge-shaped groove.

4. The method of claim 3, wherein the wedge-shaped groove has two opposed, tapered surfaces that contact and deflect the excess cured lens material as the mold section is moved transverse to the groove.

5. The method of claim 1, wherein the excess cured material is adhered to a posterior mold section of the mold assembly.

6. The method of claim 1, wherein the excess cured material is adhered to an anterior mold section of the mold assembly.

7. The method of claim 6, wherein the cast lens is also adhered to the anterior mold section, and the excess cured material is removed from the cast lens and anterior mold section.

8. The method of claim 7, wherein the cast lens remains adhered to a molding surface of the anterior mold section.

9. The method of claim 1, wherein the excess cured material is removed from the mold section by vacuuming.

10. The method of claim 1, wherein the excess cured lens material is transported through two opposed, tapered surfaces that compress the excess cured lens material.

11. The method of claim 10, wherein the excess cured lens material is contacted by the opposed, tapered surfaces that compress and deflect the excess cured lens material as the mold section travels through and is guided by a separate pair of opposed surfaces.

12. The method of claim 1, wherein the lens is a contact lens.

13. An apparatus for releasing excess cured lens material adhered to a lens mold section, comprising a plate including in a surface thereof a wedge-shaped groove that contacts and deflects the excess cured lens material as the mold section is moved against the groove.

14. The apparatus of claim 13, wherein the excess cured material is adhered to an anterior mold section of the mold assembly.

15. The apparatus of claim 2, wherein a cast lens is also adhered to the anterior mold section.

16. The apparatus of claim 13, wherein the wedge-shaped grove is formed by a pair of opposed, tapered surfaces that compress the excess cured lens material.

17. The apparatus of claim 16, wherein the plate surface includes another pair of opposed surfaces that guide the mold section as is travels against the groove.

18. The apparatus of claim 17, wherein the excess cured lens material is contacted by the opposed, tapered surfaces that compress and deflect the excess cured lens material as the mold section travels through and is guided by the other pair of opposed surfaces.

19. The apparatus of claim 17, wherein the other pair of opposed surfaces have a separation closely approximately an outer diameter of an upper portion of the mold section, and the pair of opposed, tapered surfaces taper to a separation smaller than the separation of the other pair of opposed surfaces.

20. The apparatus of claim 13, wherein the lens is a contact lens.
